(19) United States
(12) Patent Application Publication
(10) Pub. No.: US 2025/0238373 A1
(43) Pub. Date: Jul. 24, 2025

(54) STORAGE CONTROLLER, STORAGE DEVICE INCLUDING THE SAME, AND OPERATING METHOD OF STORAGE DEVICE

(71) Applicant: SAMSUNG ELECTRONICS CO., LTD., Suwon-si (KR)

(72) Inventors: Yoonki LEE, Suwon-si (KR); Dongkun AN, Suwon-si (KR); Hyewon JEONG, Suwon-si (KR)

(73) Assignee: SAMSUNG ELECTRONICS CO., LTD., Suwon-si (KR)

(21) Appl. No.: 18/828,391

(22) Filed: Sep. 9, 2024

(30) Foreign Application Priority Data
Jan. 18, 2024 (KR) 10-2024-0008288

(51) Int. Cl. G06F 12/0804; G06F 12/02; G06F 13/16

(52) U.S. Cl. CPC G06F 12/0804; G06F 12/0292; G06F 13/1668

(57) ABSTRACT

Provided is a storage controller, a storage device, and an operating method of the storage device. The storage controller includes a write post-processing module configured to output a cache update request in response to a write completion; a cache processing module configured to output a cache update response based on the cache update request and release at least one of cache memory or buffer memory; and a metadata processing module configured to update mapping data, the mapping data indicating a correspondence between physical addresses and logical addresses, wherein the write post-processing module is further configured to, based on the cache update response, determine whether the mapping data is updatable, and output a mapping update request based on the determination, and the metadata processing module is further configured to update the mapping data in response to the mapping update request.

### CROSS-REFERENCE TO RELATED APPLICATION

This application is based on and claims priority under 35 U.S.C. § 119 to Korean Patent Application No. 10-2024-0008288, filed on Jan. 18, 2024, in the Korean Intellectual Property Office, the disclosure of which is incorporated by reference herein in its entirety.

### BACKGROUND

### 1. Technical Field

The embodiments of the present disclosure relates to an operating method of a storage device, and more particularly, to a storage controller, a storage device including the same, and an operating method of the storage device.

### 2. Brief Description of Related Art

Flash memory, which is non-volatile memory, may retain stored data even when power is turned off. Recently, storage devices including flash memory have been widely used for storing or moving large amounts of data. As electronic devices and communication technologies become increasingly developed, demands for improved data processing speed and performance of storage devices are increasing.

However, the amount of data processed in storage devices continues to increase, and accordingly, the need for technologies that efficiently utilize the limited resources or shorten the operation time to process large amounts of data is increasing.

### SUMMARY

Embodiments of the present disclosure provides a storage controller capable of efficiently utilizing resources and shortening the operation time, a storage device including the same, and an operating method of the storage device.

According to an aspect of the present disclosure, there is provided a storage controller including a write post-processing module configured to output a cache update request in response to a write completion; a cache processing module configured to output a cache update response based on the cache update request and release at least one of cache memory or buffer memory; and a metadata processing module configured to update mapping data, the mapping data indicating a correspondence between physical addresses logical addresses, wherein the write post-processing module is further configured to, based on the cache update response, determine whether the mapping data is updatable, and output a mapping update request based on the determination, and the metadata processing module is further configured to update the mapping data in response to the mapping update request.

According to another aspect of the present disclosure, there is provided an operating method of a storage device, the operating method including outputting a cache update request in response to a write completion; outputting a cache update response based on the cache update request; in response to outputting the cache update response, releasing at least one of cache memory or buffer memory; based on the cache update response, determining whether mapping data is updatable, the mapping data indicating a correspondence between physical addresses logical addresses; outputting a mapping update request based on the determination; and updating the mapping data in response to the mapping update request.

According to another aspect of the present disclosure, there is provided a storage device including non-volatile memory, and a controller configured to output a cache update request in response to a write completion to the non-volatile memory, output a cache update response after checking a data hazard based on the cache update request, and release at least one of cache memory and buffer memory in response to outputting the cache update response, determine whether mapping data is updatable based on the cache update response, the mapping data indicating a correspondence between physical addresses and logical addresses, and update the mapping data in response to a mapping update request based on a determination result.

### BRIEF DESCRIPTION OF DRAWINGS

Embodiments will be more clearly understood from the following detailed description taken in conjunction with the accompanying drawings in which:

FIG. 1 is a block diagram of a storage system according to an embodiment;

FIG. 2 is a block diagram of a controller of a storage device according to an embodiment;

FIG. 3 is a block diagram of an example of a flash translation layer (FTL) of a controller according to an embodiment;

FIG. 4 is a flowchart of an operating method of a storage device according to an embodiment;

FIG. 5 is a flow diagram to explain the flowchart of FIG. 4;

FIG. 6 is a block diagram of another example of an FTL of a controller according to an embodiment;

FIG. 7 is a flowchart of a read operation according to an embodiment;

FIGS. 8A to 8C are diagrams of a pending process in a read operation according to an embodiment;

FIGS. 9A to 9C are diagrams of a fetch process in a read operation according to an embodiment; and

FIG. 10 is a block diagram of an electronic device according to an embodiment.

### DETAILED DESCRIPTION

Hereinafter, embodiments are described in detail with reference to the accompanying drawings. Embodiments of the present disclosure may have diverse changes and various forms, and thus, some example embodiments are illustrated in the drawings and described in detail. However, this is not intended to limit the embodiments of the present disclosure to some specific embodiments. Also, the embodiments described below are only examples, and thus, various changes may be made to the example embodiments.

All examples and illustrative terms are only used to explain aspects of the present disclosure in detail and, thus, the scope of the present disclosure is not limited by these examples and illustrative terms.

It will be understood that when an element is referred to as being “on,” “connected to,” or “coupled to” another element, it can be directly on, connected to, or coupled to the other element or intervening elements may be present. In contrast, when an element is referred to as being “directly on,” “directly connected to,” or “directly coupled to” another element, there are no intervening elements present.

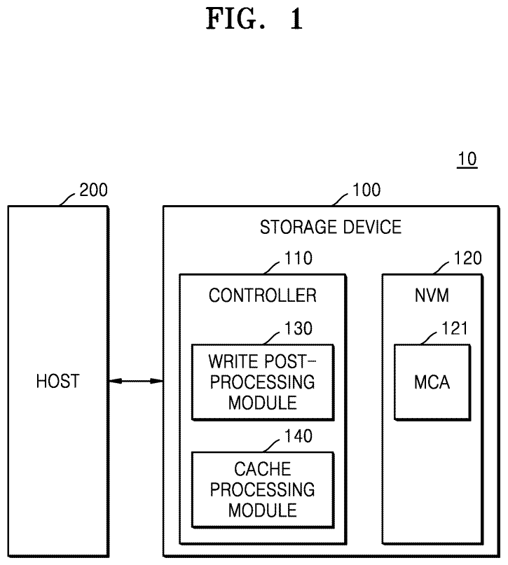

FIG. 1 is a block diagram of a storage system according to an embodiment.

Referring to FIG. 1, a storage system 10 may include a storage device 100 and a host 200. The storage device 100 may be connected to the host 200 to perform a request (e.g., command) from the host 100. In an embodiment, the host 200 may be implemented as an application processor (AP) or a system-on-a-chip (SoC).

The storage device 100 may be manufactured as any one of various types of storage devices according to a host interface that is a communication method with the host 200. For example, the storage device 100 may be composed of any one of various types of storage devices, such as a multimedia card in the form of a solid-state drive (SSD), a MultiMediaCard (MMC), an embedded MMC (eMMC), a reduced-size MMC (RS-MMC), and a micro-MMC, a secure digital card in the form of a Secure Digital (SD), a mini-SD, and a micro-SD, a universal storage bus (USB) storage device, a universal flash storage (UFS) device, a storage device in the form of a personal computer memory card international association (PCMCIA) card, a storage device in the form of a peripheral component interconnect (PCI) card, a storage device in the form of a PCI express (PCIe) card, a compact flash (CF) card, a smart media card, a memory stick, and the like.

The storage device 100 may include a controller 110 and non-volatile memory (NVM) 120. The controller 110 may control the overall operation of the storage device 100 on its own or in response to a request from the host 200. For example, the controller 110 may control the NVM 120 to read data stored in the NVM 120 or write data to the NVM 120, in response to a write/read request (e.g., command) from the host 200. The host 200 may communicate with the storage device 100 through various interfaces and may transmit a write/read request and the like to the storage device 100.

The NVM 120 may include a memory cell array (MCA) 121, wherein the MCA 121 may include, for example, a metadata area for storing metadata and a storage area for storing user data. As an example, the MCA 121 may include flash memory cells. For example, the flash memory cells may include NAND flash memory cells. However, the present disclosure is not limited thereto. The memory cells may include resistive memory cells, such as a resistive RAM (ReRAM) memory cells, a phase-change RAM (PRAM) memory cells, and a magnetic RAM (MRAM) memory cells.

In some embodiments, the controller 110 may include a write post-processing module 130 and a cache processing module 140. The write post-processing module 130 may be a module for overall control of processes after a write operation to the NVM 120 is completed. The write post-processing module 130 may transmit a cache update request to the cache processing module 140 in response to completing the write operation to the NVM 120. The cache processing module 140 may check a data hazard in response the cache update request. In some embodiments, the cache processing module 140 may release data in cache memory and/or buffer memory after checking the data hazard.

According to an embodiment, when the write operation to the NVM 120 is completed, the controller 110 of the storage device 100 may release data in the cache memory and/or the buffer memory without waiting for the metadata (e.g., mapping data) to be updated, thereby reducing the memory occupancy time due to the operation. Accordingly, the controller 110 may improve the efficiency of resources, such as cache memory or buffer memory. For example, when the controller 110 according to an embodiment performs consecutive write commands, the time when the cache memory and/or the buffer memory is used due to each write operation may be reduced, which allows a greater amount of operations to be performed in the same amount of time. In embodiments, even when both the cache memory and/or the buffer memory are used due to a plurality of write commands, the controller 110 according to an embodiment may release and reuse the memories at an earlier time, thereby improving the performance of the storage device 100.

The storage system 10 may be implemented as, for example, a personal computer (PC), a data server, a network-attached storage (NAS), an Internet of Things (IoT) device, or a portable electronic device. The portable electronic device may include a laptop computer, a mobile phone, a smartphone, a tablet PC, a personal digital assistant (PDA), an enterprise digital assistant (EDA), a digital still camera, a digital video camera, an audio device, a portable multimedia player (PMP), a personal navigation device (PND), an MP3 player, a handheld game console, an e-book, a wearable device, and the like.

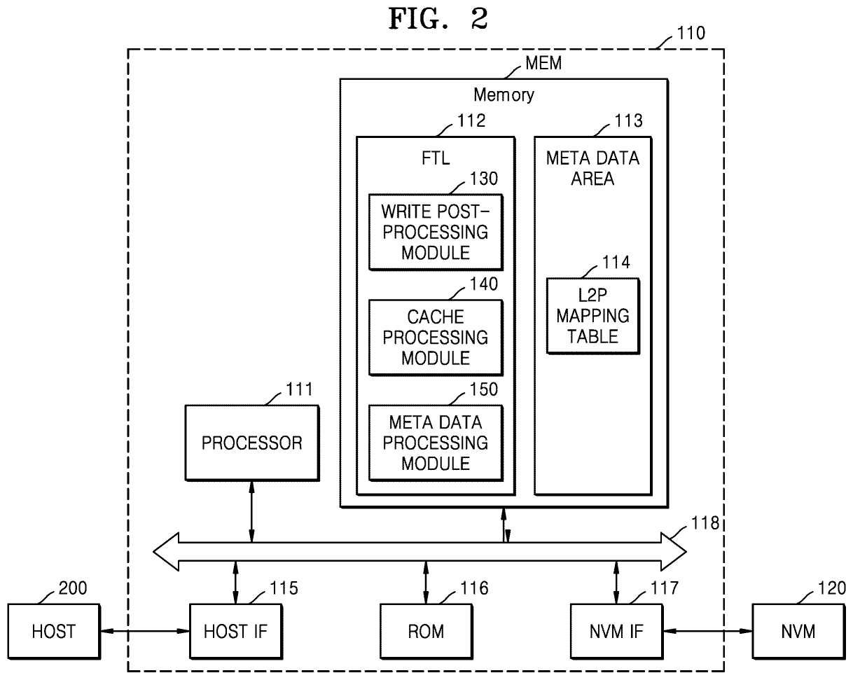

FIG. 2 is a block diagram of a controller of a storage device according to an embodiment.

Referring to FIGS. 1 and 2, the controller 110 may include memory MEM, a processor 111, a host interface 115, read-only memory (ROM) 116, and an NVM interface 117, which may communicate with each other through a bus 118. The processor 111 may include a central processing unit (CPU), a microprocessor, and the like and may control the overall operation of the controller 110. The controller 110 may communicate with the host 200 of FIG. 1 through the host interface 115. The communication method may be variously implemented according to the type of the host interface 115. In addition, the controller 110 may communicate with the NVM 120 of FIG. 1 through the NVM interface 117.

The memory MEM may operate under the control by the processor 111 and may be used as operation memory, buffer memory, or cache memory. For example, the memory MEM may be implemented as volatile memory, such as dynamic random-access memory (DRAM) and static random-access memory (SRAM), or as NVM, such as PRAM and flash memory. Hereinafter, the memory MEM, which is volatile memory, may be described focusing on an embodiment implemented as DRAM. Thus, hereinafter, DRAM may refer to memory loaded with metadata.

The memory MEM may include a flash translation layer (FTL) 112 and a metadata area 113. The FTL 112 may be a layer for interaction between the host 200 and the NVM 120. The metadata area 113 may be an area for storing data representing mapping information. The FTL 112 may include a write post-processing module 130, a cache processing module 140, and a metadata processing module 150. The metadata area 113 may include a logical to physical (L2P) mapping table 114 for mapping between a logical address and a physical address. The FTL 112 may further include a wear-leveling module, a bad block management module, a garbage collection module, an error correction code (ECC) module, and an encryption/decryption module, depending on functions implemented by firmware. The term “module” as used in the above modules and the following refers to software or hardware components, such as a field programmable gate array (FPGA) or an application specific integrated circuit (ASIC). The “module” may perform certain functions. However, the “module” is not limited to software or hardware. The “module” may be configured to be on an addressable storage medium and may be configured to reproduce one or more processors. Thus, as an example, the “module” may include components, such as software components, object-oriented software components, class components, and task components, processes, functions, attributes, procedures, subroutines, segments of program code, drivers, firmware, microcode, circuitry, data, databases, data structures, tables, arrays, and variables. The functionality provided in the components and “modules” may be combined into a smaller number of components and “modules” or may be further separated into additional components and “modules”.

The write post-processing module 130 may perform processes after the write operation by communicating with the cache processing module 140 and the metadata processing module 150 in response to completion of the write operation to the NVM 120. In some embodiments, the write post-processing module 130 may release data in the memory by transmitting a request to the cache processing module 140 as described below and may update the metadata (e.g., mapping data) by transmitting the request to the metadata processing module 150.

The cache processing module 140 may release data stored in the cache memory and/or the buffer memory in response to the request from the write post-processing module 130. More specifically, the cache processing module 140 may first release data in the cache memory and/or the buffer memory before the metadata (e.g., the L2P mapping table 114) is updated. Accordingly, the controller 110 according to an embodiment may improve efficiency in using resources, such as the cache memory and/or the buffer memory. In addition, the cache processing module 140 may check the data hazard in response to the request from the write post-processing module 130. That is, the cache processing module 140 may check the data hazard so that the write post-processing module 130 determines whether the metadata is updatable. The cache processing module 140 may provide the result of checking the data hazard to the write post-processing module 130, and the write post-processing module 130 may determine whether the metadata (e.g., mapping data) is updatable based thereon.

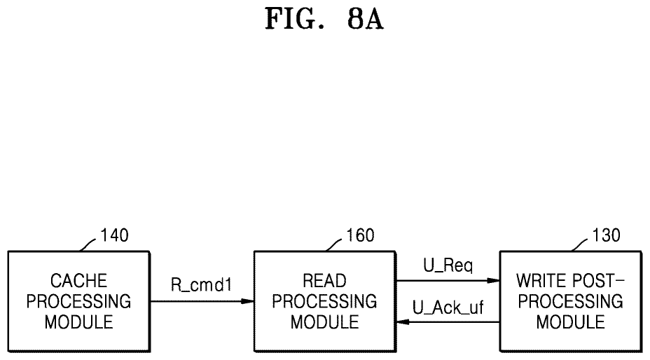

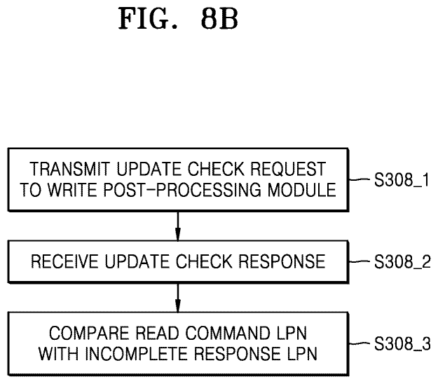

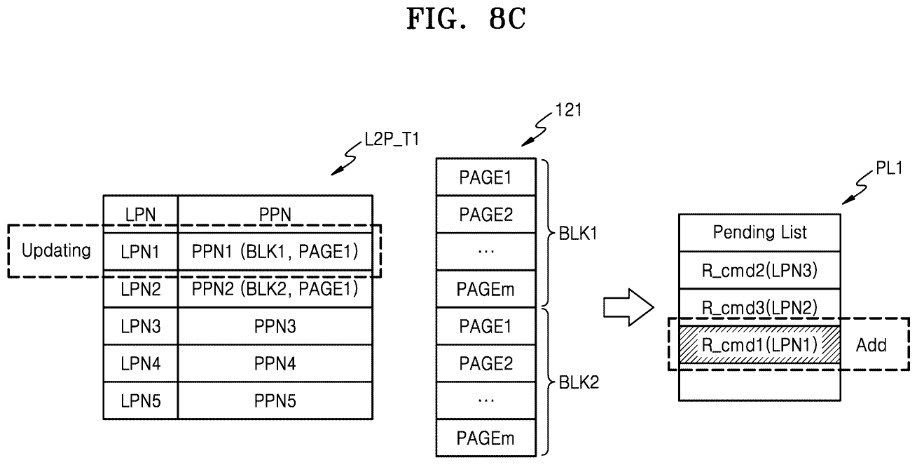

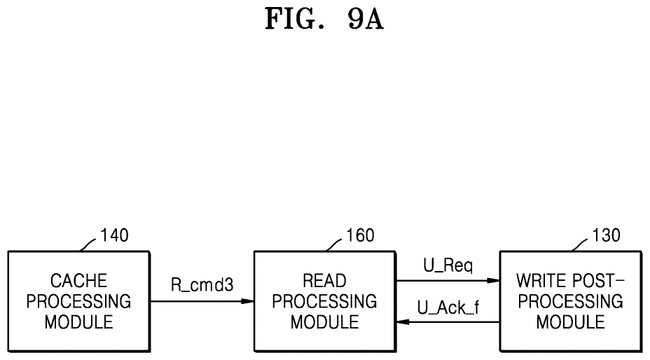

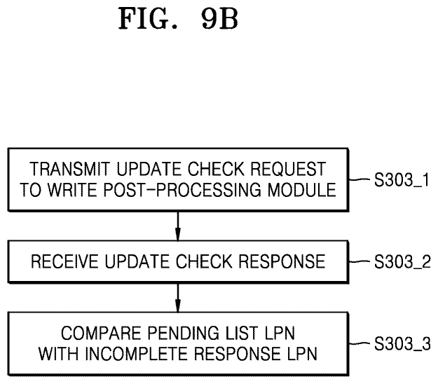

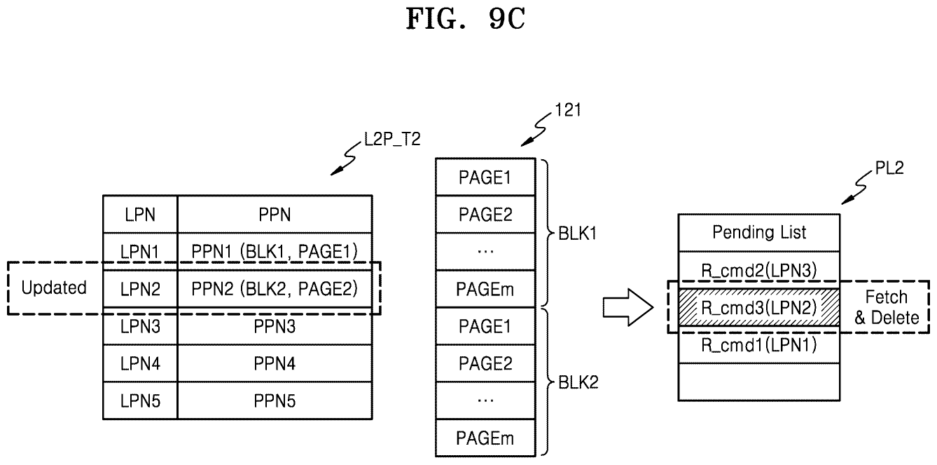

The metadata processing module 150 may update the metadata stored in the metadata area 113 in response to the request from the write post-processing module 130. The metadata may include at least one piece of mapping data representing mapping information between a logical address (e.g., a logical page number (LPN)) of the host 200 and a physical address (e.g., a physical page number (PPN)) of the NVM 120, physical block information representing information of pages included in each physical block of the NVM 120, trim data representing data deleted from the host 200, and a directory representing a physical address in which the metadata, such as mapping data or physical block information, is stored in the metadata area 113 of the NVM 120. When power is applied to the storage device 100 of FIG. 1, for example, when the storage system 10 is booted, the metadata stored in the metadata area 113 of the NVM 120 may be loaded into the controller 110. The metadata area 113 may include the L2P mapping table 114 that is mapping data and the physical block information. The L2P mapping table 114 may include data for converting a logical address into a physical address. The physical block information may include data representing information of pages included in the physical block. The mapping data and the physical block information are described below with reference to FIGS. 8C and 9C.

In an embodiment, the write post-processing module 130, the cache processing module 140, and the metadata processing module 150 may be implemented in the FTL 112 and are shown to be loaded into the memory MEM. However, as described above, the present disclosure is not limited thereto. The modules (i.e., the write post-processing module 130, the cache processing module 140, and the metadata processing module 150) may be implemented as hardware. In an embodiment, the FTL 112 and the metadata area 113 may be implemented in the same chip. However, the present disclosure is not limited thereto. The FTL 112 and the metadata area 113 may be implemented in different chips.

The host interface 115 may provide an interface between the host 200 and the controller 110 by providing at least one of various communication methods, such as USB, serial advanced technology attachment (SATA), small computer system interface (SCSI), serial attached SCSI (SAS), high speed inter-chip (HSIC), PCI, PCIe, NVM express (NVMe), UFS, secure digital (SD), multimedia card (MMC), embedded MMC (eMMC), dual in-line memory module (DIMM), registered DIMM (RDIMM), and load reduced DIMM (LRDIMM). The NVM interface 117 may provide an interface between the controller 110 and the NVM 120. For example, the L2P mapping table 114, block information, write data, and read data may be exchanged between the controller 110 and the NVM 120 through the NVM interface 117. The ROM 116 may store code data necessary for initial booting of the storage device 100.

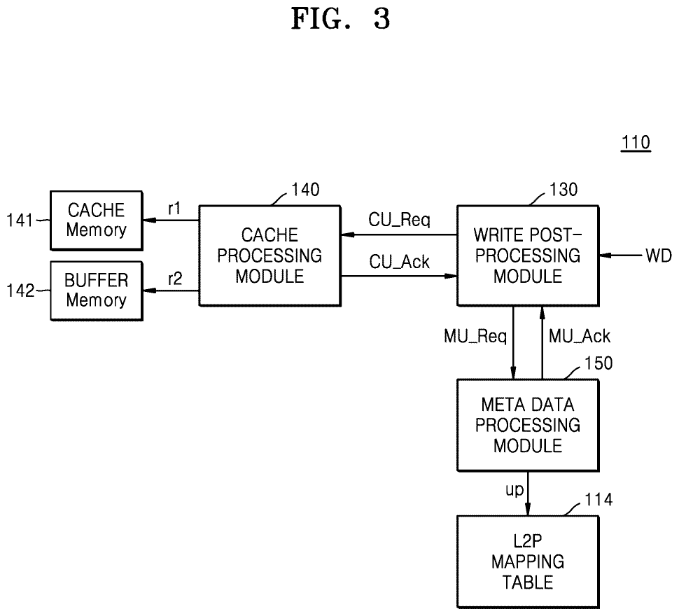

FIG. 3 is a block diagram of an example of an FTL of a controller according to an embodiment.

Referring to FIGS. 2 and 3, the controller 110 may release data in cache memory 141 and/or buffer memory 142 and may update mapping data (e.g., L2P mapping table 114), based on transmission and reception of signals between the write post-processing module 130, the cache processing module 140, and the metadata processing module 150.

The write post-processing module 130 may receive a write completion WD upon completing the write operation to the NVM and may output a cache update request CU_Req in response to the write completion WD. The cache processing module 140 may perform an update operation of the cache memory 141 and/or the buffer memory 142 in response to the cache update request CU_Req and may check a data hazard and output a cache update response CU_Ack. The write post-processing module 130 may determine whether the mapping data is updatable based on the received cache update response CU_Ack. When it is determined that the mapping data is updatable, the write post-processing module 130 may output a mapping update request MU_Req to the metadata processing module 150. The metadata processing module 150 may output and transmit a mapping update response MU_Ack to the write post-processing module 130 upon completion of updating the mapping data, and the write post-processing module 130 may determine whether the update operation is completed based thereon.

The cache processing module 140 may release data in the cache memory 141 and/or the buffer memory 142 in response to the cache update request CU_Req received from the write post-processing module 130. The cache processing module 140 may release (i.e., delete) data in the cache memory 141 by transmitting a first release signal r1 to the cache memory 141 and may release (i.e., delete) data in the buffer memory 142 by transmitting a second release signal r2 to the buffer memory 142. In addition, in some embodiments, the cache processing module 140 may check the data hazard in response to the cache update request CU_Req received from the write post-processing module 130. In other words, in order for the write post-processing module 130 to determine whether the mapping data is updatable, the cache processing module 140 may check whether the data hazard has occurred, and the cache processing module 140 may output and transmit the cache update response CU_Ack including the result of checking the data hazard to the write post-processing module 130.

For example, the cache processing module 140 may check whether a write after write (WAW), that is, consecutive write commands include the same logical address. In an embodiment, the cache processing module 140 may receive the consecutive write commands. After receiving the first write command, the cache processing module 140 may receive a subsequent second write command. When the first write command and the second write command include the same logical address, the cache processing module 140 may determine that the data hazard has occurred. That is, since the data hazard (i.e., a WAW hit) in which consecutive write operations are performed for the same logical address has occurred, the cache processing module 140 may output the cache update response CU_Ack indicating that the data hazard has occurred. The write post-processing module 130 may determine that the mapping data is not updatable based on the received cache update response CU_Ack. The write post-processing module 130 may not output the mapping update request MU_Req.

The metadata processing module 150 may update the L2P mapping table 114 through a table update signal up. The metadata processing module 150 may receive the mapping update request MU_Req from the write post-processing module 130 and may output the table update signal up in response thereto. The L2P mapping table 114 may include a plurality of pieces of mapping data, wherein each piece of mapping data may represent a physical address (e.g., PPN) corresponding to a logical address (e.g., LPN). For example, referring to a first L2P mapping table L2P_T1 of FIG. 8C, a physical address corresponding to a second logical address LPN2 may be a second physical address PPN2, wherein the second physical address PPN2 may represent a first page PAGE1 of a second block BLK2 included in an MCA 121 of the NVM 120. The physical address mapped to the second logical address LPN2 by subsequent operations (e.g., write operations) may be changed in the first page PAGE1 of the existing second block BLK2, and the metadata processing module 150 may update the L2P mapping table 114 to correspond to the change in the physical address.

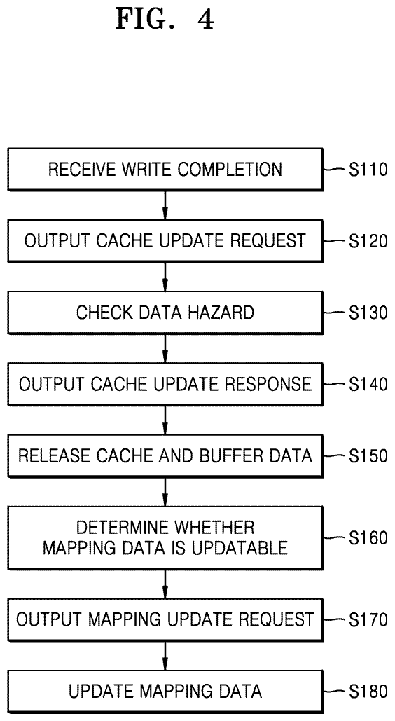

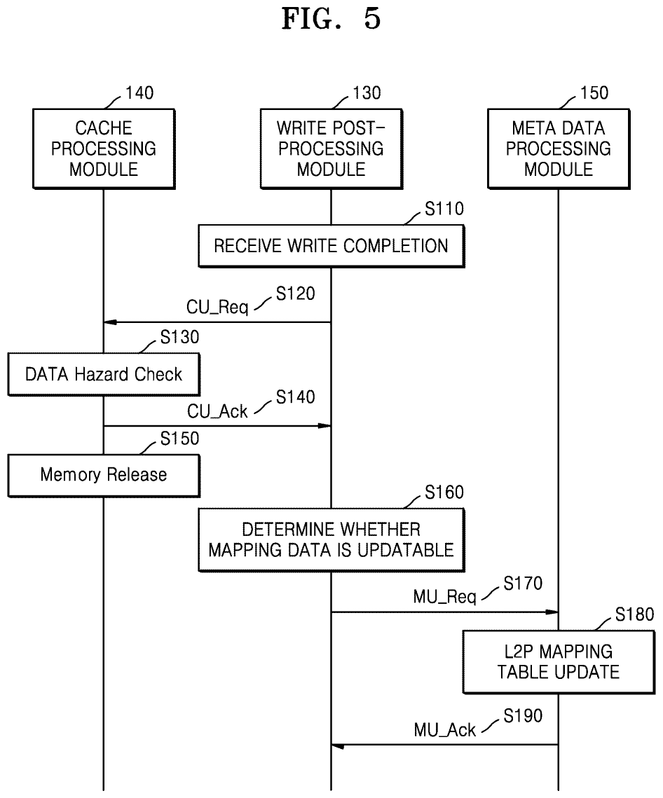

FIG. 4 is a flowchart of an operating method of a storage device according to an embodiment. FIG. 5 is a flow diagram to explain the flowchart of FIG. 4.

Referring to FIGS. 3 to 5, the controller 110 may release data in the cache memory and/or the buffer memory before updating the mapping data based on transmission and reception of requests and responses between the write post-processing module 130, the cache processing module 140, and the metadata processing module 150.

In operation S110, the write post-processing module 130 may receive the write completion WD from the NVM upon completing the write operation.

In operation S120, the write post-processing module 130 may output and transmit the cache update request CU_Req to the cache processing module 140 in response to the write completion WD.

In operation S130, the cache processing module 140 may check the data hazard in response to the cache update request CU_Req received from the write post-processing module 130. For example, the cache processing module 140 may determine whether the WAW hit has occurred by checking the logical address of consecutive write commands.

In operation S140, the cache processing module 140 may output and transmit the cache update response CU_Ack including the result of checking the data hazard to the write post-processing module 130. The write post-processing module 130 may determine whether the mapping data is updatable by checking whether the data hazard has occurred.

In operation S150, the cache processing module 140 may release (i.e., delete) data in the cache memory 141 and/or the buffer memory 142 in response to the cache update request CU_Req received from the write post-processing module 130 in operation S120. That is, the operation of releasing the cache memory 141 and/or the buffer memory 142 by the cache processing module 140 may be performed before the write post-processing module 130 determines whether the mapping data is updateable.

As such, an embodiment may use resources more efficiently by releasing and utilizing cache memory and/or buffer memory as available resources without waiting for the metadata to be updated. For example, when the controller is performing consecutive commands or when both the cache memory and/or the buffer memory are being used due to a plurality of commands, etc., the memories may be released and reused without waiting for the metadata to be updated upon completion of executing the commands, thereby efficiently reducing the time for executing the operations.

In addition, an embodiment may simplify the write post-processing process to achieve optimization by determining a data hazard and releasing cache memory and/or buffer memory together, thereby reducing the time and cost required for the write post-processing process.

In operation S160, the write post-processing module 130 may determine whether the mapping data is updatable based on the cache update response CU_Ack received from the cache processing module 140. That is, the write post-processing module 130 may determine whether the metadata is updatable based on the result of checking the data hazard included in the cache update response CU_Ack. For example, when receiving the cache update response CU_Ack indicating the data hazard (e.g., WAW hit) has occurred, the write post-processing module 130 may determine that the mapping data is not updatable. On the other hand, when receiving the cache update response CU_Ack indicating that the data hazard has not occurred, the write post-processing module 130 may determine that the mapping data is updatable.

In operation S170, when it is determined that the mapping data is updatable, the write post-processing module 130 may output and transmit the mapping update request MU_Req to the metadata processing module 150. In an embodiment, the mapping update request MU_Req may include information on a logical address and a physical address for updating the L2P mapping table 114.

In operation S180, the metadata processing module 150 may update the mapping data (e.g., the L2P mapping table 114) in response to the mapping update request MU_Req received from the write post-processing module 130. For example, when the physical address mapped to a specific logical address is changed, the metadata processing module 150 may update the L2P mapping table 114 to correspond to the change.

In operation S190, when the mapping data has been updated, the metadata processing module 150 may output and transmit the mapping update response MU_Ack to the write post-processing module 130. The write post-processing module 130 may determine whether the mapping data has been updated based on the mapping update response MU_Ack.

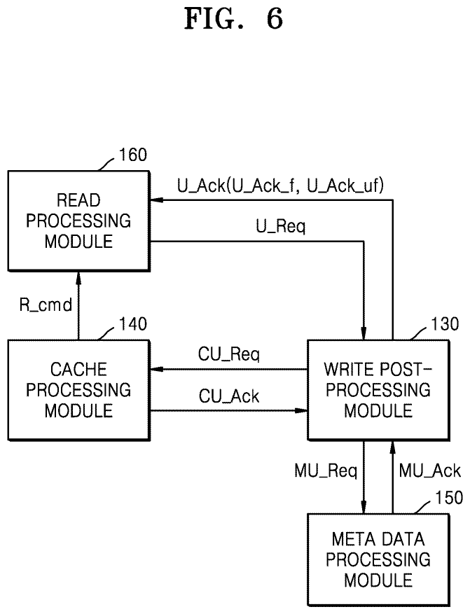

FIG. 6 is a block diagram of another example of an FTL of a controller according to an embodiment.

Referring to FIG. 6, the controller 110 may further include a read processing module 160. Hereinafter, FIG. 6 is described with reference to the previous drawings, and descriptions overlapping with those in the previous drawings are omitted.

The cache processing module 140 may transmit a read command R_cmd received from the host or the like to the read processing module 160. The read processing module 160 may access the NVM and perform a read operation based on a logical address included in the read command R_cmd received from the cache processing module 140.

In some embodiments, the read processing module 160 may control the read operation by controlling a pending list to prevent the data hazard that may occur due to the release of the cache memory and/or the buffer memory before updating the metadata. More specifically, since the controller according to an embodiment releases the cache memory and/or the buffer memory before updating the metadata, data of the physical address prior to being updated may be read when a request (e.g., read request) for the logical address to be updated is made after the cache memory and/or the buffer memory is released and before the metadata is updated. To prevent the data hazard (i.e., read after write (RAW) hit), the read processing module 160 may suspend the read operation by configuring the pending list based on the logical address of the mapping data that is being updated or is waiting for the update (e.g., the update is not completed).

In some embodiments, the read processing module 160 may suspend the read operation based on the pending list including pending data including information about a logical address of the mapping data which has not been updated, whereas the suspended read operation may be performed based on the pending information when the mapping data corresponding to the pending data has been updated. In some embodiments, the write post-processing module 130 may output and transmit an update check response U_Ack representing the update status of the mapping data to the read processing module 160. That is, the update check response U_Ack may include an incomplete response U_Ack_uf including information about a logical address that is being updated or waiting for the update or may include a complete response U_Ack_f including information about a logical address which has been updated. The read processing module 160 may control the pending list based on the update check response U_Ack and may determine whether to perform or suspend the read process according to the read command R_cmd.

In an embodiment, the read processing module 160 may transmit an update check request U_Req to the write post-processing module 130 to determine whether the mapping data has been updated, and the write post-processing module 130 may output and transmit the update check response U_Ack in response thereto to the read processing module 160.

As a result, the read processing module 160 may prevent the occurrence of the data hazard by suspending the operation when the logical address, which has not been updated, is accessed, and then performing the operation that was suspended when the logical address is updated. That is, the controller according to an embodiment may advance the time for releasing the cache memory and/or the buffer memory to efficiently utilize resources as well as to prevent the occurrence of the data hazard.

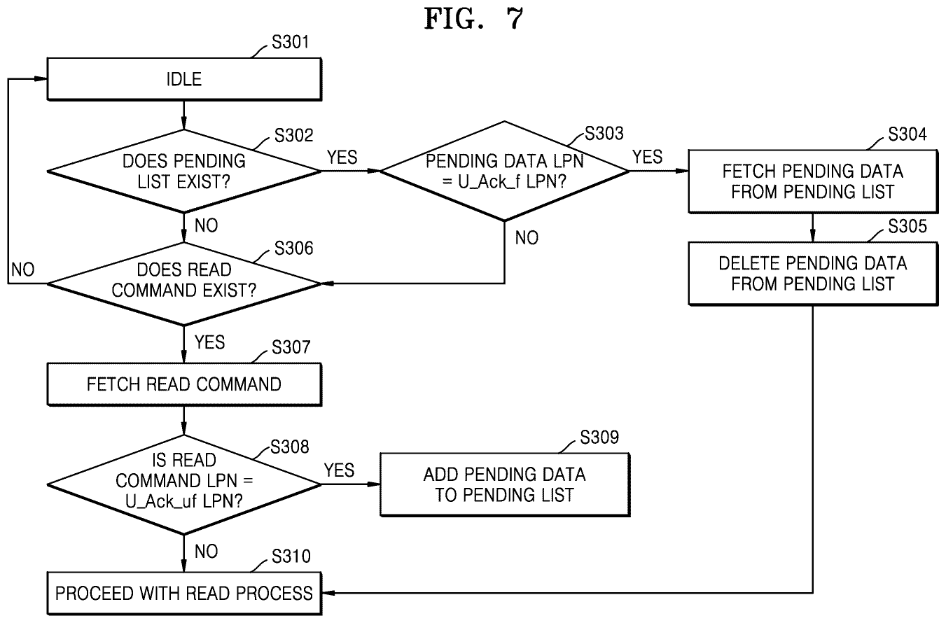

FIG. 7 is a flowchart of a read operation according to an embodiment.

Referring to FIGS. 6 and 7, the read processing module 160 may prevent the data hazard by suspending the read operation based on the pending list. Hereinafter, FIG. 7 is described with reference to the previous drawings, and descriptions that are substantially the same as those of the previous drawings are omitted.

In operation S301, the read processing module 160 may be in an idle state in which an operation is not performed.

In operation S302, the read processing module 160 may determine whether the pending list exists. For example, the read processing module 160 may determine whether the queue size of the pending list is 0. Since the existence of the pending list means that there is a logical address which has not been updated, the read processing module 160 may determine whether the pending read operation can be performed.

That is, in operation S303, as described above, the read processing module 160 may receive the update check response U_Ack, wherein the update check response U_Ack may include a complete response U_Ack_f including information about the logical address which has been updated. The read processing module 160 may compare the logical address of each pending data included in the pending list with the logical address of the complete response U_Ack_f.

When the logical address of first pending data included in the pending list is the same as the logical address of the complete response U_Ack_f (YES in operation S303), this means that the mapping data for the logical address to be accessed by the pending read command has been updated. Thus, the read processing module 160 may perform an operation according to the command based on the first pending data. That is, in operation S304, the read processing module 160 may fetch the first pending data from the pending list. Since fetching of pending data means that the pending operation proceeds, the read processing module 160 may delete the first pending data from the pending list in operation S305. Thereafter, in operation S310, the read processing module 160 may proceed with the pending read process based on the fetched pending data.

On the other hand, when the logical address of the plurality of pieces of pending data included in the pending list is different from the logical address of the complete response U_Ack_f (No in operation S303), this means that the updated logical address is not related to the pending command (i.e., the pending data). Thus, the read processing module 160 may perform an operation according to the read command R_cmd without referring to the pending list.

That is, in operation S306, the read processing module 160 may determine whether the read command R_cmd exists. When the read command R_cmd does not exist (NO in operation S306), there is no need to perform an additional operation. Thus, the read processing module 160 may enter the idle state (operation S301).

On the other hand, when the read command R_cmd exists (YES in operation S306), the read processing module 160 may fetch the read command R_cmd to perform the read operation according to the read command R_cmd in operation S307.

In operation S308, as described above, the read processing module 160 may receive the update check response U_Ack, wherein the update check response U_Ack may include the incomplete response U_Ack_uf including information about the logical address that is being updated or waiting for the update. The read processing module 160 may compare the logical address of the received read command R_cmd with the logical address of the incomplete response U_Ack_uf.

When the logical address of the read command R_cmd is the same as the logical address of the incomplete response U_Ack_uf (YES in operation S308), this means that the mapping data for the logical address to be accessed by the read command R_cmd has not been updated. Therefore, in operation S309, the read processing module 160 may add the read command R_cmd as the pending data to the pending list to suspend the access by the read command R_cmd (i.e., to prevent the data hazard) until the mapped data is updated.

On the other hand, when the logical address of the read command R_cmd is different from the logical address of the incomplete response U_Ack_uf (NO in operation S308), this means that the logical address to be accessed by the read command R_cmd is not related to whether the mapping data has been updated. Therefore, in operation S310, the read processing module 160 may proceed with the read process according to the fetched read command R_cmd.

As such, by controlling the pending operation based on the pending list, the controller according to the embodiment may advance the time for releasing the cache memory and/or the buffer memory to efficiently utilize resources as well as to prevent the occurrence of the data hazard.

FIGS. 8A to 8C are diagrams of a pending process in a read operation according to an embodiment.

Referring to FIGS. 8A to 8C, the read processing module 160 may suspend access to the logical address that has not been updated by the read command. FIGS. 8A to 8C are described below with reference to the previous drawings, and descriptions that are substantially the same as those of the previous drawings are omitted.

In an embodiment, the read processing module 160 may receive a first read command R_cmd1 from the cache processing module 140. In some embodiments, in operation S308_1, the read processing module 160 may transmit the update check request U_Req to the write post-processing module 130 to determine whether the mapping data has been updated.

In operation S308_2, the read processing module 160 may receive the update check response U_Ack including the incomplete response U_Ack_uf including the logical address which has not been updated. In an embodiment, the incomplete response U_Ack_uf may include information about a first logical address LPN1. Accordingly, as shown in FIG. 8C, the mapping data corresponding to the first logical address LPN1 has not been updated in the first L2P mapping table L2P_T1 including the first logical address LPN1. That is, the physical address corresponding to the first logical address LPN1 is a first physical address PPN1, wherein the first physical address PPN1 refers to a first page PAGE1 of a first block BLK1 included in the MCA 121 of the NVM 120. However, as a result of the update, a physical position indicated by the first physical address PPN1 in the MCA 121 may be changed.

In operation S308_3, the read processing module 160 may compare the logical address of the first read command R_cmd1 with the logical address of the incomplete response U_Ack_uf. Accordingly, as shown in FIG. 8C, the logical address to be accessed by the first read command R_cmd1 may be the first logical address LPN1. That is, the logical address to be accessed by the first read command R_cmd1 and the logical address of the incomplete response U_Ack_uf may be the same as the first logical address LPN1. The read processing module 160 may determine that the first physical address PPN1 corresponding to the first logical address LPN1 to be accessed by the first read command R_cmd1 has not been updated. Thus, the read processing module 160 may add the first read command R_cmd1 as the pending data to a first pending list PL1 to suspend the access to the physical address (i.e., the first page PAGE1 of the first block BLK1) before the update is made (i.e., to prevent the data hazard).

FIGS. 9A to 9C are diagrams of a fetch process in a read operation according to an embodiment.

Referring to FIGS. 9A to 9C, when the mapping data for the logical address to be accessed by the pending read command has been updated, the read processing module 160 may perform an operation according to the pending read command. Hereinafter, FIGS. 9A to 9C are described with reference to the previous drawings, and descriptions that are substantially the same as those of the previous drawings are omitted.

In an embodiment, the read processing module 160 may receive a third read command R_cmd3 from the cache processing module 140, wherein the received third read command R_cmd3 may be a command suspended from the access (i.e., command added to the pending list), as a result of the determination by the read processing module 160. In some embodiments, in operation S303_1, the read processing module 160 may transmit the update check request U_Req to the write post-processing module 130 to determine whether the mapping data has been updated.

In operation S303_2, the read processing module 160 may receive the update check response U_Ack including a complete response U_Ack_f including the logical address which has been updated. In an embodiment, the complete response U_Ack_f may include information about the second logical address LPN2. This may mean that, as shown in FIG. 9C, in a second L2P mapping table L2P_T2 including the second logic address LPN2, the mapping data corresponding to the second logical address LPN2 has been updated. That is, this may mean that the physical address corresponding to the second logical address LPN2 is the second physical address PPN2, and, as a result of the update, a physical location indicated by the second physical address PPN2 is changed to a second page PAGE2 of the second block BLK2 included in the MCA 121 of the NVM 120.

In operation S303_3, the read processing module 160 may compare the logical address of the second pending list PL2 with the logical address of the complete response U_Ack_f. Accordingly, the second logical address LPN2 of the complete response U_Ack_f may be the same as the pending data included in the second pending list PL2, as shown in FIG. 9C. That is, this means that the second physical address PPN2 corresponding to the second logical address LPN2 to be accessed by the third read command R_cmd3 previously received by the read processing module 160 has been updated. Thus, the read processing module 160 may fetch the pending data from the second pending list PL2 to proceed with the operation according to the pending third read command R_cmd3. Thereafter, the read processing module 160 may delete the pending data from the second pending list PL2.

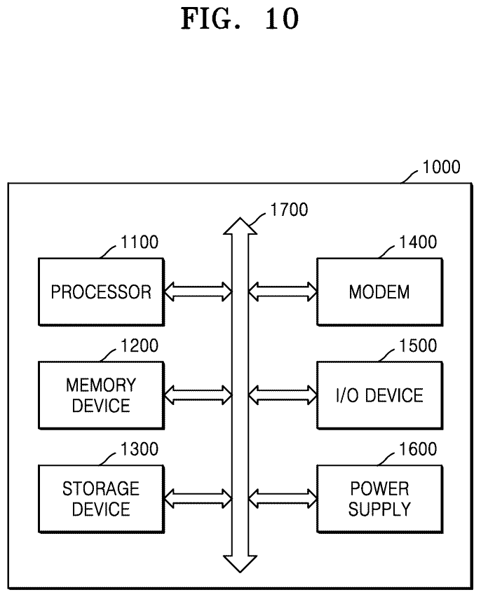

FIG. 10 is a block diagram of an electronic device according to an embodiment.

Referring to FIG. 10, an electronic device 1000 may include a processor 1100, a memory device 1200, a storage device 1300, a modem 1400, an input/output device 1500, and a power supply 1600. In an embodiment, when the data write operation is completed, the storage device 1300 may release the cache memory and/or the buffer memory before updating the metadata. In addition, the storage device 1300 may prevent the data hazard by controlling the pending list to determine whether the read operation is suspended. Accordingly, the storage device 1300 may advance the time for releasing the cache memory and/or the buffer memory to efficiently utilize resources as well as to prevent the occurrence of the data hazard.

While the present disclosure has been particularly shown and described with reference to embodiments thereof, it will be understood that various changes in form and details may be made therein without departing from the spirit and scope of the following claims.

What is claimed is:

1. A storage controller comprising:
a write post-processing module configured to output a cache update request in response to a write completion;
a cache processing module configured to output a cache update response based on the cache update request and release at least one of cache memory or buffer memory; and
a metadata processing module configured to update mapping data, the mapping data indicating a correspondence between physical addresses and logical addresses,
wherein the write post-processing module is further configured to, based on the cache update response, determine whether the mapping data is updatable, and output a mapping update request based on the determination, and
the metadata processing module is further configured to update the mapping data in response to the mapping update request.

2. The storage controller of claim 1, wherein the cache processing module is further configured to check a data hazard in response to the cache update request and output the cache update response based on a result of checking the data hazard.

3. The storage controller of claim 2, wherein the cache processing module is further configured to:
receive a first write command and a second write command, the second write command being received after the first write command, and
check the data hazard by comparing a logical address of the first write command to a logical address of the second write command.

4. The storage controller of claim 1, wherein the metadata processing module is further configured to output a mapping update response indicating that the mapping data has been updated.

5. The storage controller of claim 1, further comprising a read processing module configured to receive a read command from the cache processing module, and control a pending list comprising pending data, wherein the pending data comprises a logical address of the mapping data which has not been updated.

6. The storage controller of claim 5, wherein the read processing module is further configured to receive, from the write post-processing module, an update check response indicating whether the mapping data has been updated.

7. The storage controller of claim 6, wherein the read processing module is further configured to perform a read operation, based on the read command and the update check response.

8. The storage controller of claim 6, wherein the update check response comprises an incomplete response, wherein the incomplete response comprises the logical address of the mapping data which has not been updated, and
wherein the read processing module is further configured to add the read command to the pending data when a logical address of the read command is the same as a logical address of the incomplete response.

9. The storage controller of claim 6, wherein the update check response comprises a complete response, the complete response comprising a logical address of the mapping data which has been updated, and
wherein the read processing module is further configured to, when a logical address of at least one piece of pending data is the same as a logical address of the complete response, fetch the at least one piece of pending data.

10. The storage controller of claim 9, wherein the read processing module is further configured to delete the at least one piece of pending data from the pending list.

11. An operating method of a storage device, the operating method comprising:
outputting a cache update request in response to a write completion;
outputting a cache update response based on the cache update request;
in response to outputting the cache update response, releasing at least one of cache memory or buffer memory;
based on the cache update response, determining whether mapping data is updatable, the mapping data indicating a correspondence between physical addresses and logical addresses;
outputting a mapping update request based on the determination; and
updating the mapping data in response to the mapping update request.

12. The operating method of claim 11, wherein the outputting of the cache update response comprises checking a data hazard in response to the cache update request and outputting the cache update response based on a result of checking.

13. The operating method of claim 12, wherein the checking of the data hazard comprises:
receiving a first write command and a second write command, the second write command being received after the first write command, and
comparing a logical address of the first write command to a logical address of the second write command.

14. The operating method of claim 11, further comprising performing a read operation in response to receiving a read command, and
wherein the performing of the read operation comprises controlling a pending list, the pending list comprising pending data for determining whether to suspend the read operation according to the read command.

15. The operating method of claim 14, wherein the performing of the read operation further comprises receiving an update check response indicating whether the mapping data has been updated.

16. The operating method of claim 15, wherein the update check response comprises an incomplete response, the incomplete response comprising a logical address of the mapping data which has not been updated, and
wherein the controlling of the pending list comprises adding the read command to the pending data when a logical address of the read command is the same as a logical address of the incomplete response.

17. The operating method of claim 15, wherein the update check response comprises a complete response, the complete response comprising a logical address of the mapping data which has been updated, and
wherein the controlling of the pending list comprises, when a logical address of at least one piece of pending data is the same as a logical address of the complete response, fetching the at least one piece of pending data.

18. The operating method of claim 17, wherein the controlling of the pending list comprises deleting the at least one piece of pending data from the pending list.

19. A storage device comprising:
non-volatile memory; and
a controller configured to:
output a cache update request in response to a write completion to the non-volatile memory,
output a cache update response after checking a data hazard based on the cache update request, and release at least one of cache memory and buffer memory in response to outputting the cache update response,
determine whether mapping data is updatable based on the cache update response, the mapping data indicating a correspondence between physical addresses and logical addresses, and
update the mapping data in response to a mapping update request based on a determination result.

20. The storage device of claim 19, wherein the controller is further configured to:
control a pending list comprising pending data based on an update check response, wherein the pending data comprises a logical address of the mapping data which has not been updated, and wherein the update check response indicates whether the mapping data has been updated, and
fetch at least one piece of pending data when a logical address of the at least one piece of pending data is same as a logical address of a complete response, wherein the complete response comprises a logical address of the mapping data which has been updated.
